(19) United States
(12) Patent Application Publication
(10) Pub. No.: US 2012/0042076 A1
(43) Pub. Date: Feb. 16, 2012

(54) METHOD AND APPARATUS FOR MANAGING APPLICATION RESOURCES VIA POLICY RULES

(75) Inventors: Claude Kawa, Montreal (CA); Nikolai Grigoriev, Brossard (CA); Sylvain Fortin, St-Laurent (CA)

(73) Assignee: Nokia Corporation, Espoo (FI)

(21) Appl. No.: 12/857,082

(22) Filed: Aug. 16, 2010

(51) Int. Cl. G06F 15/173

(52) U.S. Cl. 709/226

(57) ABSTRACT

An approach is provided for managing resources. One or more policy rules for managing one or more resources of an application executing at a device are determined. The one or more policy rules are determined to be applied for selecting the one or more resources from among a set of resources.

### BACKGROUND

Service providers and device manufacturers (e.g., wireless, cellular, etc.) are continually challenged to deliver value and convenience to consumers by, for example, providing compelling network services. One aspect of providing such services (e.g., instant messaging, electronic mail, social networking, etc.) includes facilitating the development of client applications for use across a broad range of networks, devices, and the like over which the services operate. By way of example, network operators often request versions of client applications that are customized specifically for a particular network. In many cases, the customizations relate to resources (e.g., graphical resources such as logos, icons, audio cues, etc.) that uniquely identify the respective network operators or other service providers, while the underlying application code remains substantially the same across different versions of the client application. As a result, the service providers and device manufactures face significant technical challenges to enabling efficient customization (e.g., dynamic customization) of resources that are used by client applications.

### SOME EXAMPLE EMBODIMENTS

Therefore, there is a need for an approach to control the customization process, including the resource(s) utilized. A policy that identifies the resource(s) affected and defines management rules for the affected resource(s) can be applied.

According to one embodiment, a method comprises determining one or more policy rules for managing one or more resources of an application executing at a device. The method also comprises determining to apply the one or more policy rules for selecting the one or more resources from among a set of resources.

According to another embodiment, an apparatus comprises at least one processor, and at least one memory including computer program code, the at least one memory and the computer program code configured to, with the at least one processor, cause, at least in part, the apparatus to determine one or more policy rules for managing one or more resources of an application executing at a device. The apparatus is also caused to determine to apply the one or more policy rules for selecting the one or more resources from among a set of resources.

According to another embodiment, a computer-readable storage medium carries one or more sequences of one or more instructions which, when executed by one or more processors, cause, at least in part, an apparatus to determine one or more policy rules for managing one or more resources of an application executing at a device. The apparatus is also caused to determine to apply the one or more policy rules for selecting the one or more resources from among a set of resources.

According to another embodiment, an apparatus comprises means for determining one or more policy rules for managing one or more resources of an application executing at a device. The apparatus also comprises means for determining to apply the one or more policy rules for selecting the one or more resources from among a set of resources.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of managing resources using policy rules, according to one embodiment;

FIG. 1B is a diagram of an example system capable of managing resources using policy rules, according to one embodiment;

FIG. 2 is a diagram of the components of user equipment capable of implementing policy rules, according to one embodiment;

FIG. 3 is a diagram of a policy data store structure that can be utilized for managing resources using policy rules, according to one embodiment;

FIG. 4 is a flowchart of a process for managing resources using policy rules, according to one embodiment;

FIG. 5 is a flow diagram of a process for utilizing policy rules to retrieve resources, according to one embodiment;

FIG. 6A-6C are diagrams of user interfaces utilized in the processes of FIGS. 4 and 5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for applying policy rules to acquire resources are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

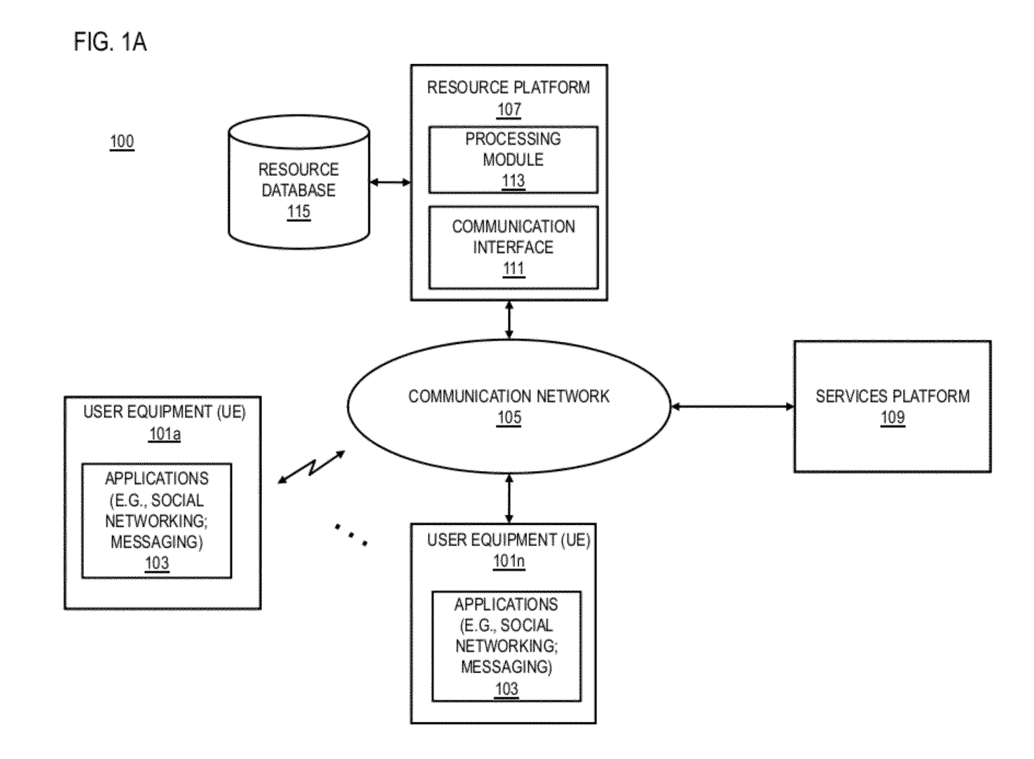

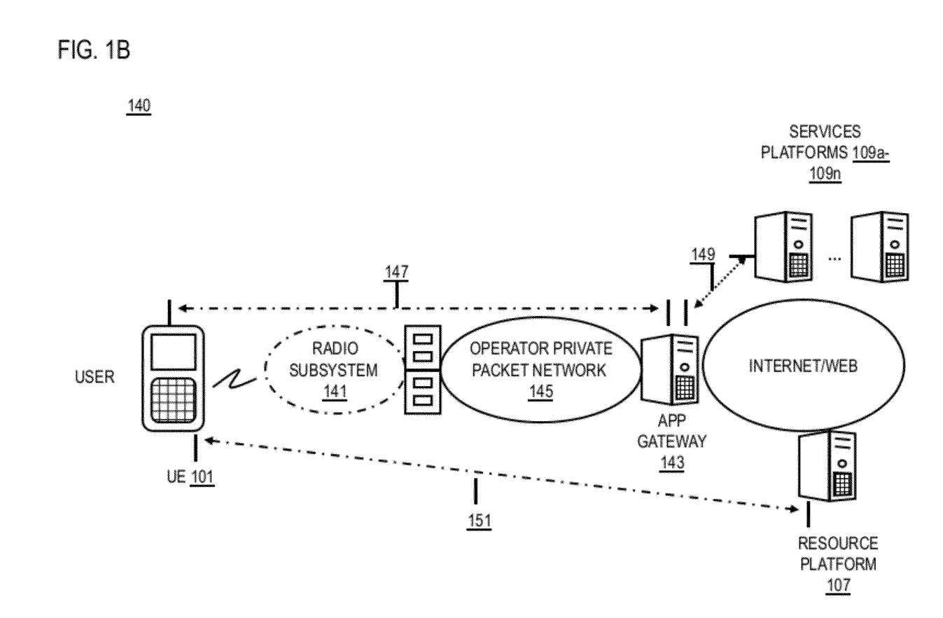

FIG. 1A is a diagram of a system capable of managing resources using policy rules, according to one embodiment. In certain embodiments, a resource is a data object that can be utilized by one or more devices. As previously noted, network services implemented on devices may include such services as instant messaging, e-mail, social networking, providing access to communities, etc. However, each service provider or network operator providing the network services may implement different resources to customize their individual services or the client applications used to access the services. In certain embodiments, a network operator is the provider of a network that a particular device receives a connection to a communication network through and a service provider is the provider of a particular service (e.g., e-mail, games, social networking, messaging, etc.) that the user of the particular device utilized. Each of these operators, service providers, or other stakeholder parties may desire to customize resources associated with one or more applications (e.g., client applications) executing on a device. For example, in a mobile environment, a network operator may wish to customize operation of an instant messaging user interface with graphics (e.g., icons, emoticons, banners, presentation styles, etc.) associated with the network operator. Traditionally, customization of service applications means that a different version of the application is created for each network operator, service provider, device, etc., thereby leading to a potentially large number of application versions that a service provider has to maintain and support.

By way of example, one method of customizing such resources is to include the resources in the corresponding client application before the client is loaded on the device and/or shipped to a user for sale. Alternatively, the resources can be downloaded or otherwise retrieved from a repository or other source (e.g., a remote server) by the client. Downloading resources from a server rather than embedding the resources on the client provides for a more flexible solution for obtaining the resources at the device. However, significant challenges are faced in determining what, when, where, how, etc. to obtain the resources at the device. For example, user experience can be degraded if the resource download causes delay and reduces the responsive of a client application (e.g., when resources are downloaded at an initial splash screen of a client application). Moreover, downloading of resources may cost money due to one or more types of network service the user has. As such, blindly downloading every available resource may not be ideal.

To address these problems, a system 100 of FIG. 1A introduces the capability to utilize policy rules to manage resources at one or more user equipment (UEs) 101a-101n executing respective client applications 103 that can be used across multiple networks, services, devices, etc. accessible over the communication network 105. More specifically, the policy rules may be applied by, for instance, the resource platform 107 to select one or more resources from among a set of resources to customize a common client application 103. By way of example, the set of resources may include a database 115 of resources that are specific to a device, network, provider, or any other applicable category. In this way, a service provider does not need to develop a different version of the client application 103 for each desired customization, thereby advantageously reducing the burden associated with maintaining and supporting multiple versions of the same software application. Instead, in one embodiment, the client application 103 can interact with the resource platform 107 to retrieve and apply the policy rules so that the rules can download or otherwise retrieve customized resources according to specific criteria (e.g., network in which the application is operating, the specific service provider, the type of device executing the client application, etc.).

In certain embodiments, a resource is a data object that can be utilized by one or more of the UEs 101a-101n. In some embodiments, the resource is utilized by an application 103 (e.g., a social networking application, an e-mail application, a messaging application, etc.). A resource can include media resources such as graphical resources (e.g., banners, emoticons, etc.), policy rules, uniform resource locators (URLs) (e.g., server addresses, customer care URLs, etc.), identifiers, and other information. Moreover, resources can be customized based on one or more parties (e.g., stakeholders such as a network operator, a service provider, etc.). The customizations may occur based on one or more policy rules. In one embodiment, the policy rule itself may be a resource than can be dynamically retrieved and updated. It is also contemplated that policy rules can be recursive (e.g., a policy rule may reference another policy rule within it) to provide further customizations. In certain embodiments, policy rules specify one or more criteria or processing characteristics, such as when the UE 101 should download one or more resources over a communication network 105 from a resource platform 107. Downloading resources from the resource platform 107 provides a flexible solution because it removes the need and the cost to include customized resources in a client application 103. Accordingly, the same client application 103 may be distributed for use any network or service. Then the client application 103 may access one or more of the policy rules to dynamically customize the application 103 according to the one or more criteria associated with the operating environment (e.g., network, service, device, available bandwidth, network congestion, etc.).

As discussed earlier, including customized resources for one or more service providers and/or network operators in the manufacturing and/or packaging phase of creating a UE 101 for a consumer has overhead costs and/or technological costs. For example, an overhead cost may exist in creating multiple separate client applications for the UE 101 based on the individual service provider and/or network operator. An example of a technological cost would be that additional memory would be used in storing multiple customizations. This could be undesirable for UEs 101 with limited storage capabilities. Also, hard-coded resources make it more difficult to quickly update the application to reflect new resources (e.g., new themes, redesigned graphics, features, rules, etc.). Moreover, hard-coded resources make it more difficult or inefficient (e.g., requires more storage space) to use the same client application 103 across networks, devices, services, etc.).

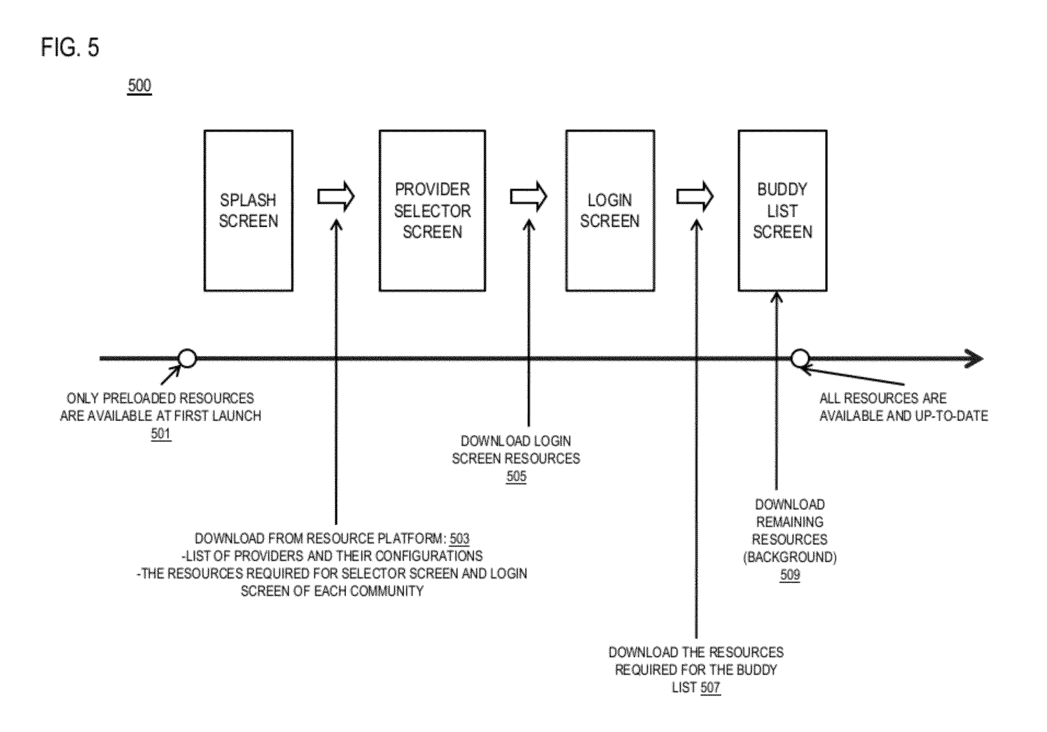

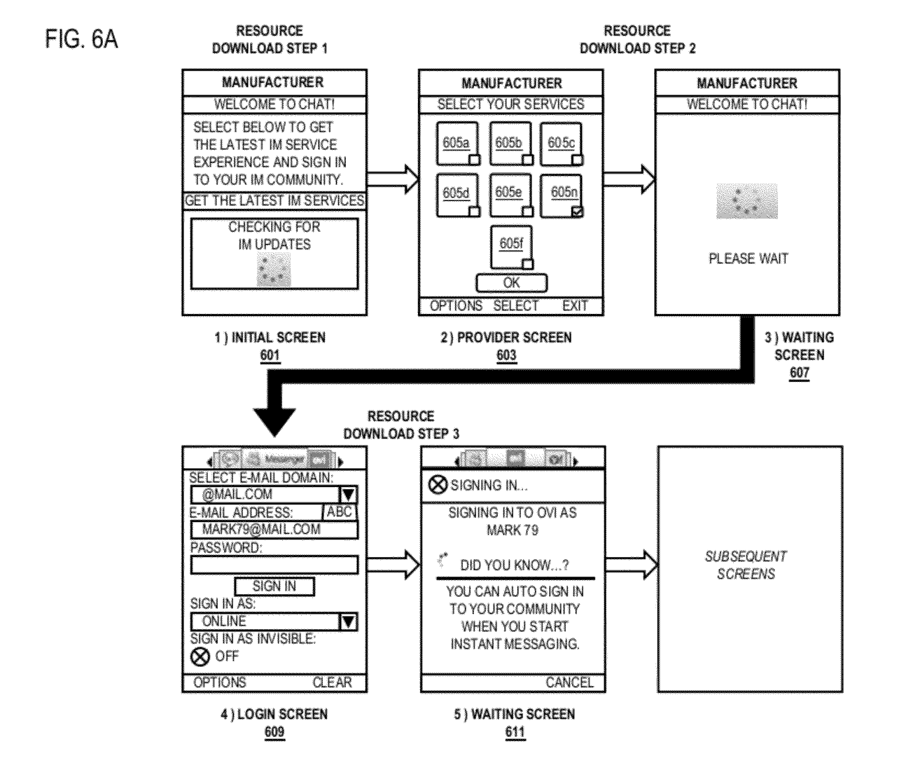

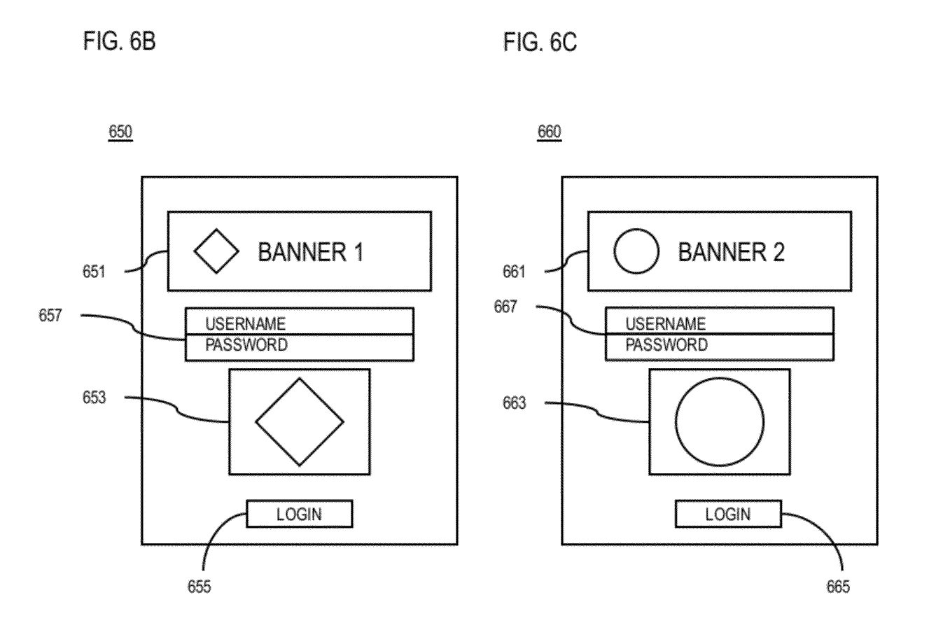

Because different operators or service providers may have different preferences and because of bandwidth concerns, and/or other reasons, determining when to download or otherwise acquire the resources may be advantageous. For example, for certain network operators (e.g., in the case of cellular phone UEs); it may be important to access and download one or more resources during activation of the UE 101. As such, criteria such as one or more timing preferences for retrieving, presenting, or otherwise managing the resources can be stored in the policy rules. Thus, in certain embodiments, the policy rules may include timings and/or states for downloading resources based on one or more parameters. The parameters may include the type of client application 103, a network operator associated with the UE 101, a service provider associated with the application 103, a connection status (e.g., connection costs, cellular network connection, wired or wireless broadband connection, etc.), a combination thereof, etc. Different parameters can affect the types of resources downloaded to the UE 101. For example, a particular network operator and one service provider (e.g., associated with a services platform 109) can utilize different resources than the particular network operator and another service provider. Moreover, one or more of the parameters can be detected by the UE 101 (e.g., the network operator). In certain embodiments, the policy rules may be downloaded during the initiation of the UE 101 allowing for one or more applications 103 to utilize the policy rules. A policy rule or other configuration information may be preloaded with an application 103 to retrieve the policy rules. In some examples, a purpose or the sole purpose of the preloaded policy rules could be to download up-to-date policy rules from a location (e.g., a known source such as an internet protocol address of the resource platform 107). In some embodiments, the first use of the client application 103 can be utilized as a state to trigger the download of the policy rules and/or other resources. Example state triggers are detailed in FIGS. 5 and 6. In one embodiment, the UE 101 includes a file that includes a URL or other identifier to the resource platform 107 to download the policy rules. In another embodiment, an initial set of policy rules are included in the manufacture of the UE 101 and/or UE software.

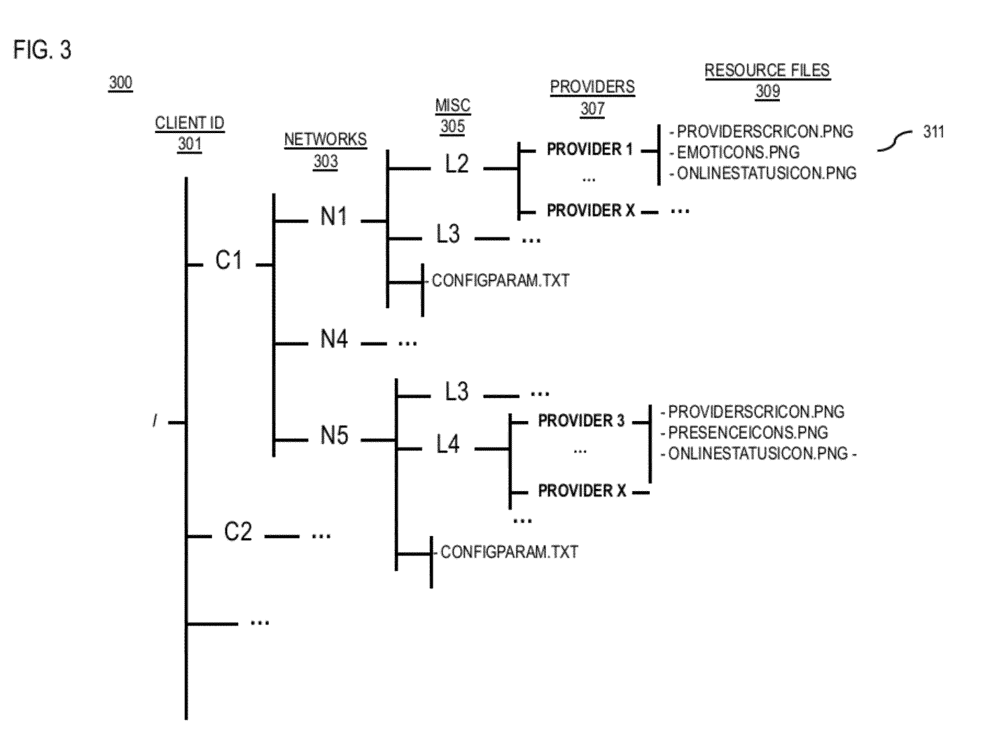

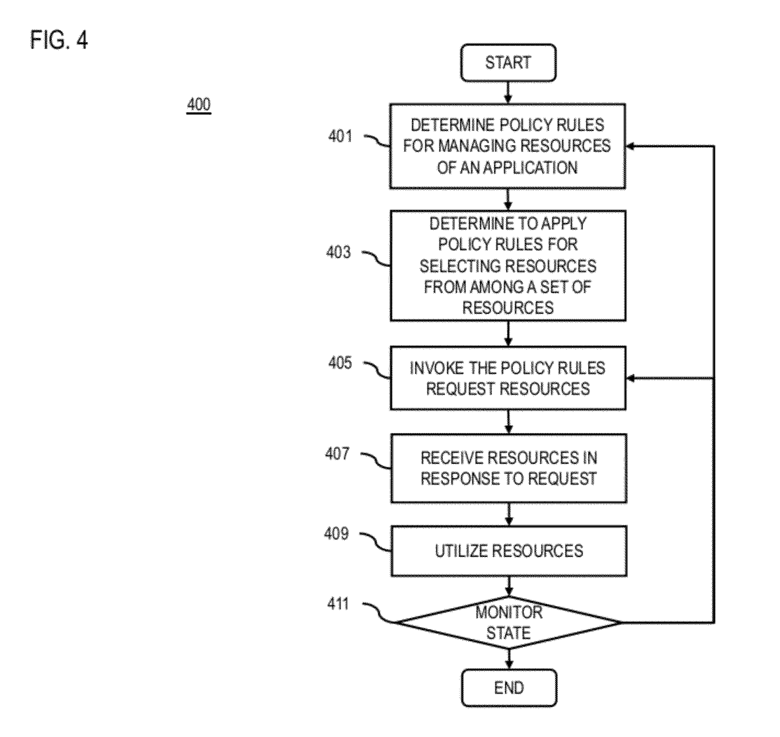

When the policy rules indicate that the UE 101 should download resources, the UE 101 can be caused to generate and transmit a request to the resource platform 107 for the resources via the communication network 105. In one embodiment, the policy rules are applied by executing the application 103. A communication interface 111 of the resource platform 107 can receive the request. Then, a processing module 113 of the resource platform 107 can parse the request and retrieve requested resources from the resource database 115 as further detailed in FIGS. 3 and 4. The communication interface 111 can then be utilized to transmit a response including the requested resources and/or substitute resources based on parameters associated with the request. For example, the request may be for a set of high definition graphic media objects stored in the resource database 115; however, the high definition graphic media objects may not be available or be subject to a modification. As such, the processing module 113 can determine to provide a set of substitute (e.g., medium definition graphic media objects) to the UE 101. The UE 101 can receive the resources and proceed with one or more operations. In certain embodiments, the resources can be necessary for the operation of the UE 101. As such, the resources may be utilized before further execution of an application 103 of the UE 101 (e.g., customized graphics that are utilized in the operation of the application 103 can be downloaded to be presented to a user of the UE 101). In other embodiments, one or more substitute or default resources can be stored on the UE 101 and accessed based on the policy rules (e.g., if a request for resources times out). In yet another embodiment, the policy rule apply criteria so that it resource platform 107 first retrieves a lower definition of the resource (e.g., that can be downloaded more quickly) before then retrieving the higher definition version of the resource. In this way, the resource platform 107 can provide a more responsive user experience while still enabling use of higher quality resources when those resources can be more readily retrieved.

In one embodiment, the policy rules can include a parameter for network congestion, bandwidth availability, type of network connection, cost of network connection, or a combination thereof. As such, the download of resources can be based, at least in part, on the available network connection to the resource platform 107. For example, the UE 101 may be caused to download all resources if a high bandwidth wireless local area network connection is detected.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, resource platform 107, and services platform 109, communicate with each other and other components of the communication network 105 using well known, new or still developing protocols. In this context, a protocol includes a set of rules defining how the network nodes within the communication network 105 interact with each other based on information sent over the communication links The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the resource platform 107 and/or services platform 109 may interact according to a client-server model with the applications 103 of the UE 101. According to the client-server model, a client process sends a message including a request to a server process, and the server process responds by providing a service (e.g., messaging, e-mail, gaming, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 1B is a diagram of an example system 140 capable of managing resources using policy rules, according to one embodiment. In this embodiment, the UE 101 can act in a mobile environment connected to a communication network via an operator radio subsystem 141. The radio subsystem 141 can be utilized to communicate with an application gateway 143 via a packet network 145 (e.g., an operator private packet network). As such, the operator can create an interface 147 (e.g., an application programming interface (API), messaging interface, etc.) between the application gateway 143 and the UE 101. The application gateway 143 can then communicate with one or more services platforms 109a-109n. In certain embodiments, an application 103 of the UE 101 can connect to a particular services platform 109 based on a user preference, availability, etc. The application gateway 143 can utilize another interface 149 to connect to the services platforms 109. Communication between the application gateway 143 and services platforms 109 may use a protocol specific to the service provider associated with the services platform 109. In certain embodiments, a role of the application gateway 143 is to perform mappings between one or more protocols used to communicate with the UE 101 and protocols used to communicate with the services platforms 109.

In certain embodiments, an interface 151 between the UE 101 and the resource platform 107 can be implemented using the application gateway 143, the packet network 145, the radio subsystem 141, as well as other communication networks. The UE 101, when manufactured, or at some other point can include an address (e.g., a URL) to the resource platform 107 to access information stored on the resource platform 107.

In some embodiments, the first time the UE 101 is utilized or activated, the first time a particular application is utilized, etc., the UE 101 contacts the resource platform 107 to download an initial policy rule that directs the application to download an initial set of resources or other policy rules to customize the application. In this way, the same application may be stored at any UE 101 regardless of network, service, or other customizations. The customizations may then be retrieved and/or performed according to the policy rules retrieved or downloaded by the application. By way of example, a default policy rule may be stored on the UE 101 before sale to the end user. The policy rule may reference, for instance, a configuration file can include a list of selectable or available service providers. As such, in certain examples, service provider information associated with resources can be caused to be presented on a display associated with the UE 101.

As previously noted, the policy rules can include rules (e.g., criteria-based rules) to manage the download of resources from the resource platform 107 for customizing the application. Moreover, additional configuration parameters that may be utilized by the user or UE 101 such as a customer care phone number or URL, etc. can be included in the configuration file referenced or retrieved by the policy rules. Additionally, as discussed above, the policy rules can include a time period, a time interval, a UE state, etc. to determine when to check the resource platform 107 for updated resources.

Once the initial policy rule is obtained and/or applied at the UE 101, the UE 101 can utilize the list of service providers to download the resources of the service providers available to the user. Further, the policy rules can be utilized to determine when to download the resources the UE 101 desires or requires. As previously noted, the policy rules can be defined to meet a stakeholder party need or requirement. For example, a stakeholder may include a network operator (e.g., Verizon™, Sprint™, etc.) or application service provider (e.g., an instant messaging service provider such as Yahoo! Messenger™, Nokia Ovi Messaging™, etc.).

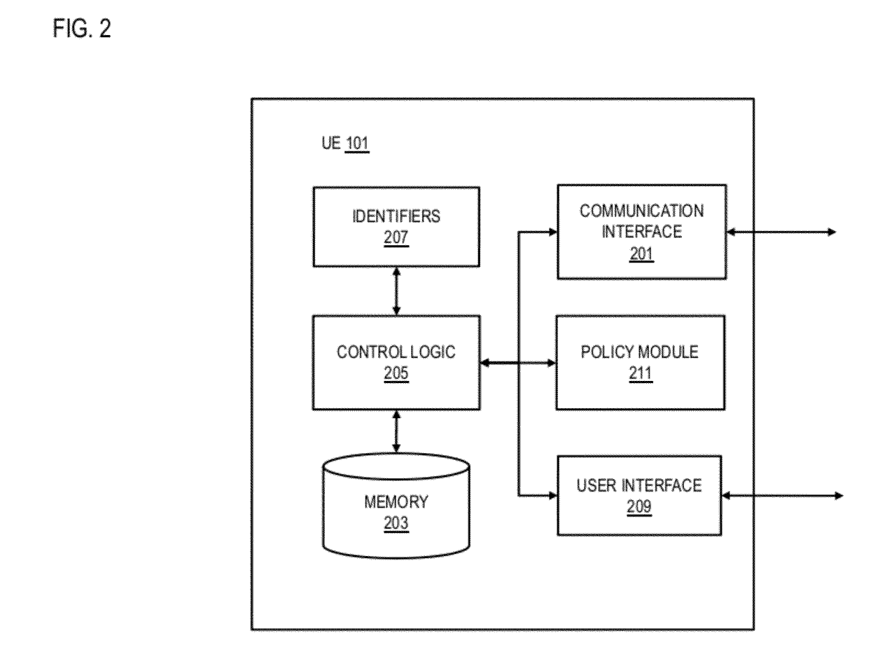

FIG. 2 is a diagram of the components of user equipment capable of implementing policy rules, according to one embodiment. By way of example, the UE 101 includes one or more components for implementing the policy rules to manage resources used by a client application. It is contemplated that the functions of these components may be combined in one or more components or performed by other components of equivalent functionality. In this embodiment, the UE 101 includes a communication interface 201, a memory 203, control logic 205, one or more identifiers 207, a user interface 209, and a policy module 211.

In one embodiment, the communication interface 201 can be used to communicate with the resource platform 107 and services platforms 109. Certain communications can be via methods such as an internet protocol, messaging (e.g., Short Message Service (SMS), Multimedia Messaging Service (MMS), etc.), or any other communication method (e.g., via the communication network 105). In some examples, the UE 101 can send requests and receive resources from the resource platform 107. Additionally, the UE 101 can receive services from the services platform 109. Further, the communication interface 201 can be utilized to communicate with other UEs 101.

Further, the control logic 205 can utilize the communication interface 201 to download resources to store in memory 203. Moreover, the communication interface 201 can be utilized to request and receive policy rules and corresponding configuration files. The policy rules can be stored in the memory 203.

The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In certain embodiments, the user interface 209 and/or control logic 205 can be means for presenting graphical resources to users as well as communicating services to users.

In one scenario, one or more identifiers 207 are utilized by the policy module 211 to determine what resources to acquire via the communication interface 201. For example, the identifiers 207 may include a client identifier that identifies a client and/or provides information about the UE 101 (e.g., device type, version of the hardware and/or software on the UE 101, etc.). Different client types may be associated with different resources. Moreover, the identifiers 207 may include a mobile network identifier identifying an operator of a communication network 105 that the UE 101 is part of Moreover, other identifiers 207 (e.g., an identifier of a selected service and/or service provider) can be on the UE. In one embodiment, one or more of the identifiers 207 are detected via a hardware chip (e.g., a Subscriber Identity Module (SIM)) or stored in memory 203.

The policy module 211 can parse configuration information and/or policy rules in the memory 203 to determine when to acquire resources via the communication interface 201. Further, in certain instances, during execution of an application 103, the user interface 209 can display one or more resources to the user. During the execution of the application 103, the user interface 209 can be caused to present the resources at one or more states of the application 103 as further detailed in FIGS. 5 and 6.

FIG. 3 is a diagram of a policy data store structure that can be utilized for managing resources using policy rules, according to one embodiment. This policy data store structure can be implemented via the resource platform 107 and/or UE 101. Thus, the resources stored on the resource platform 107 can be organized according to a hierarchical structure 300. Although this embodiment is described with respect to a hierarchical structure 300, it is contemplated that the approach described herein may be used with other organizations of data (e.g., via an index, via a file allocation method, etc.).

In this embodiment, a top level of the structure includes a Client identifier (ID) level 301 that identifies a client application and provides information about the device type and/or version of a client UE 101. Different client types may have different associated resources. The next level in this embodiment includes a network ID level 303 that identifies one or more networks that the UE 101 is associated with (e.g., a mobile network ID). Moreover, a miscellaneous level 305 of the hierarchy can be associated with one or more parameters. Such parameters may include one or more languages supported by the associated network, a configuration file, etc. Further, the hierarchy may include an application provider level 307 tying an application service to a service provider. Additionally or alternatively, the application provider level 307 may include a folder of resource files 309 for each service provider. The final level includes the resource files.

In certain embodiments, the hierarchical structure 300 can mimic a computer file system organization where folders can include other folders and/or files as shown. Further, to access a particular resource, the client application 103 on the UE 101 can specify an associated pathname associated with the user's UE 101. For example, to access the Emoticons.png file under a first provider, the client can specify a path “/C1/N1/L2/Provider 1/Emoticons.png.” In another example, the UE 101 can include in a request for resource files parameters for the Client ID, network ID, miscellaneous parameter (e.g., a language), a provider ID, a combination thereof, etc.

The hierarchical structure 300 can be utilized in dynamically selecting resource files 309 based on one or more parameters that can be selected using one or more policy rules. In other words, the hierarchical structure 300 categorizes resources according to one or more service providers, themes, context conditions, etc. that can be selected by the one or more policy rules to customize services, applications, etc. at the UE 101. For example, one “emoticons.png” resource 311 can be selected if parameters C1, N1, L2, and provider 1 are determined to be associated with a particular runtime of an application 103 while another resource (not shown) can be selected if parameters C1, N1, L2, and provider 3 detected. As such, the resources can be quickly and easily maintained and accessed from the structure 300. Moreover, because the structure 300 can be maintained on the resource platform 107, changes to particular resources (e.g., changing icons or branding for a particular service) can be made to the structure 300 instead of to the individual applications 103 running on each UE 101 as done under conventional approaches.

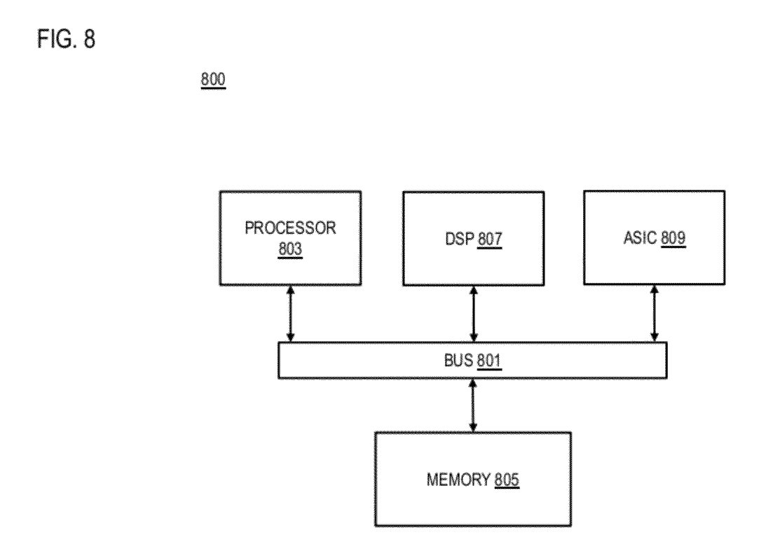

FIG. 4 is a flowchart of a process for managing resources using policy rules, according to one embodiment. In one embodiment, the control logic 205 of the UE 101 performs the process 400 and is implemented in, for instance, a chip set including a processor and a memory as shown in FIG. 8. As such, the control logic 205 can provide means for accomplishing various parts of the process 400 as well as means for accomplishing other processes in conjunction with other components of the UE 101.

In certain embodiments, the user of a UE 101 initiates usage of the UE 101 or an application 103 of the UE 101. As the application 103 initializes a user interface is displayed to the user. The user interface can include a user interface scene (e.g., a screen, a dialog, a particular user interface interaction, etc.). Control logic 205 can determine that a scene has been triggered to implement one or more steps of process 400.

In step 401, the control logic 205 determines one or more policy rules for managing one or more resources of an application 103 executing at the UE 101. In certain embodiments, the determination can be caused in response to an initialization of the application 103. In some examples, the policy rules can be pre-stored on the UE 101. In other examples, the policy rules can be caused to be requested from a services platform 109 and/or a resource platform 107. As previously noted, a memory 203 of the UE 101 can include policy rules and/or information as to where to request policy rules from (e.g., an address of the resource platform 107). As such, the information may be hard coded into an application 103 resident on the UE 101 while the policy rules can be downloaded separately. As such, one or more of the policy rules can be separate from code associated with the application 103.

Then, at step 403, the control logic 205 determines to apply the one or more policy rules for selecting the one or more resources from among a set of resources. The application can be caused based on a determination of one or more execution times, states, or a combination thereof of the application 103. FIGS. 5 and 6 detail various user interfaces of execution time and state examples. In certain embodiments, the policy rules include one or more criteria for selecting resources based, at least in part, on a service provider, an operator (e.g., a network operator, another party associated with a communication network the UE 101 is connected to, etc.), language setting (e.g., a selected language setting, available languages, etc.) or a combination thereof of the UE 101. In certain instances, the criteria can be based on one or more identifiers 207 (e.g., a SIM card) that can be referenced in the policy rules. In other embodiments, application state changes (e.g., user interface events such as a selection, command, gesture, screen transition, etc.) can trigger application of a policy for determining the retrieval of one or more resources.

Then, at step 405, the policy rules can be invoked to request resources (e.g., from an external device such as the resource platform 107). Table 1 shows an example policy rule structure that can be invoked, including a rule component, an explanation of the rule component, example syntax associated with the rule component, and examples. Additional rules are contemplated and the table of rules is merely for example.

TABLE 1

| Rule | Role of the rule | | |
|---|---|---|---|
| component | component | Syntax | Example |
| Condition | Identifies when to | 1-Screen = “Screen Id”. | Screen = Initial (refer |
| | download the | Identifies the screen during | to FIG. 2). |
| | resource(s) identified | which the download must | The download must |
| | in the rule. In certain | occur. | occur when the initial |
| | embodiments, there | | screen is displayed. |
| | are two possibilities: | 2-Transition = “current screen | Transition = Provider |
| | 1-When a screen is | to next screen”. | selector to login. |
| | displayed | Identifies the transition from | The transition must |
| | 2-Between two | one screen to another when the | occur during the |
| | screens of the | download must occur. | transition between the |
| | application when a | | identified screens. In |
| | special “waiting | | this case a wait screen |
| | screen” is displayed. | | (e.g., FIG. 6 - screen |
| | | | 3) waiting screen 1 |
| | | | will be displayed. |
| Resource | Identifies a list of | Resources = A list of file names | checkbox, emoticons, |
| list | resources to | or relative URL separated with | presence, etc. |
| | download | commas. | |
| Qualifier | Identifies one or more | In certain embodiments, | Blocking = Initially |
| list | additional rules. | Blocking = “Always”, | |
| | In certain | “Initially” or “No”. This | |
| | embodiments, are two | qualifier indicates whether the | |
| | qualifiers: | download can be done in the | |
| | 1-Blocking | background (value = No) while | |
| | 2-WaitingMsg | the user performs some other | |
| | | activities. Or if it must be done | |
| | | in the foreground and the user | |
| | | must wait until it is completed | |
| | | (value = Always) Value = Initially | |
| | | means that the download must | |
| | | be done in the foreground the | |
| | | first time only. | |
| | | WaitingMsg = “a text message”. | WaitingMsg = “Please |
| | | This is a message to display to | wait while the update |
| | | the user while waiting for the | is progressing”. |
| | | download to complete. | |

Additional policy rules can be implemented to retrieve resources from the resource platform 107 and/or another location (e.g., a device memory, peer device, cloud computing storage, and the like). Thus, in certain embodiments, policy rules can include a condition for when to utilize the rule, a resource list of resources to obtain, and a qualifier that can provide user interface parameters. When a condition is met, the control logic 205 can generate and cause transmission of a request for associated resources. As previously noted in the discussion pertaining to FIG. 3, the policy rules can specify one or more respective pointers or parameters to the one or more resources in the request. As such one or more structures, (e.g., hierarchical structure 300) can be utilized in retrieving resources. Further, the pointers can indicate one or more alternatives if requested resources are unavailable. During this time, the qualifying parameter can be applied. In certain embodiments, the request can be caused to be transmitted to the resource platform 107 for retrieving requested resources.

In certain scenarios, while invoking the policy rules, the control logic 205 can invoke a rule qualifying parameter to utilize other resources while waiting for a request for a resource to be fulfilled. As such a default and/or other resource (e.g., a supplementary resource or alternative resource) found in a memory 203 of the UE 101 or another resource downloaded from the resource platform 107. For example, a request for a high quality image resource from the resource platform 107 do display on the UE 101 can be substituted with a medium or low quality image resource corresponding to the high quality image resource based on one or more rule components. Additionally or alternatively, default generic resources may be used as substitutes based on one or more of the policy rules. For example, if there is a cache of resources that are available in memory, the cache can be utilized temporarily as a fallback resource for certain associated resources (e.g., resources of the same type and/or associated with the same service provider or operator). The policy rules can include a primary resource and a set of fallback resources to utilize. In certain embodiments, the policy rules may additionally state that if an updated resource is available for download, the updated resource must be used.

Moreover, the policy rules may include alternative resources to utilize in response to a substitution condition (e.g., a delay in a response from the resource platform 107). For example, the control logic 205 can determine that there is a delay with retrieving a selected resource from the resource platform 107. One or more substitute resources can be utilized based, at least in part, on the delay or the existence of the delay. For example, a wait timeout can be implemented for determining when to use a substitute resource. In another example, the substitution condition can be based on one or more inputs from a user. In one instance, the application 103 can be in a user logon screen for an account. A low resolution image may be substituted for a higher resolution image until the user logs into the account. In yet another example, a substitute condition may be a default condition, where substitute resources (e.g., generic resources) are utilized until a time when better resources can be retrieved.

Further, progress messages and/or wait states may be utilized in implementing the policy rules. For example, a data service that may cost the user money is utilized, a message can be displayed to the user to determine whether the user wishes to incur such charges. Additionally or alternatively, a wait screen can be caused to be presented to the user showing a status. Moreover, the wait screen can indicate a message telling the user that the resources are being downloaded, but the user will not be charged. An agreement between a manufacturer of the UE 101 and/or client application and an operator may be utilized to download such resources without cost to the user.

Then the UE 101 receives the requested resources (step 407). In certain embodiments, the resources can include updated policy rules, configuration files, resources (e.g., graphics, media, files, documents, additional modules, etc.), a combination thereof, etc. If the resource includes an updated policy rule, the control logic 205 can determine to update at least a portion of the one or more policy rules based, at least in part, on the updated policy rule. Once the resources are received, the resources can be utilized (step 409). Example uses of resources are further detailed in FIGS. 5 and 6.

Further, as resources are being utilized, the state of one or more scenes to be presented on the UE 101 can be monitored (step 411). During the monitoring process, the UE 101 can continue to utilize resources. Additionally, the monitoring of the state can include one or more exit conditions to perform additional steps associated with obtaining and/or managing resources. These exit conditions can include a condition for determining if a policy has been modified. In certain embodiments, policy rules can be updated based on one or more criteria (e.g., after a timer, at a particular time, once a certain number of resources have been utilized, based on an expiration date, etc.). When a policy rule update is triggered, the control logic 205 can return to step 401 to re-determine the policy rules based on the update and may continue with obtaining resources. As noted above, one or more resources may not change during the process and need not be downloaded again.

Further, in certain embodiments, the policy rules can include criteria for updating resources (e.g., based on an expiration time, based on bandwidth capabilities of the UE 101, based on a timer, etc.). When a resource is to be updated or flagged to determine if the resource should be updated according to a policy rule, the control logic 205 can invoke the policy rules at (step 405).

FIG. 5 is a flow diagram of a process for utilizing policy rules to retrieve resources, according to one embodiment. In this embodiment, an instant messaging application 103 is utilized as an example to explain the flow 500. At step 501, the only resources available to the UE 101 are preloaded resources that are stored in memory 203 that are available at first launch. Then, at or after a splash screen, at step 503, the control logic 205 of the UE 101 downloads an initial policy rule (e.g., providing configuration information for retrieving additional policy rules and/or configuration files) from the resource platform 107 and/or another device. The policy rules and/or configuration file can include a list of providers and their configurations. As such, the UE 101 can download subsets of resources at each step of the user interface flow 500. Further, the policy rules can specify criteria for selecting resources that are used in a next screen to be displayed to a user of the UE 101 (e.g., a service provider selector screen).

At step 505, the UE 101 can be in a state where it is necessary or customary to show a login screen. At this step, the control logic 205 can determine to request and receive login screen resources. The login screen resources can then be caused to be presented to the user via the user interface 209. As such, a login experience coordinated with the network operator and/or service provider can be presented to the user at the login screen according to one or more policy rules. Then, the control logic 205 can download additional resources (step 507) based, at least in part, on the policy rules. For example, the policy rules can instruct the control logic 205 to determine to download additional resources in the background 509 while utilizing other functionality of the application 103. In certain embodiments, the policy rules can be utilized to download the additional resources based on criteria (e.g., importance, most likely to be used first, etc.) and may be limited to resources associated with one or more interested or stakeholder parties.

FIG. 6A is a diagram of user interfaces utilized in the processes of FIGS. 4 and 5, according to various embodiments. In in one embodiment, during an initialization screen 601 of a chatting service application, the UE 101 is caused, at least in part, to download a configuration file (e.g., a configuration file including one or more policy rules and/or updates) from a resource platform 107. The initialization screen 601 may occur during the first run of the client application or a subsequent initialization process. In certain embodiments, the updates may occur during or before an available chat services provider screen 603 is presented or in the background while other processes occur. The user is able to select one or more chat service providers 605a-605n to utilize. One or more service providers 605a-605n may be added as part of the initialization update according to one or more policy rules (e.g., if the resource platform 107 includes information associated with a new service provider (e.g., 605f) in the update).

In addition, during the configuration phase, the UE 101, as determined by one or more policies, can download the graphical resources (e.g., icons) representing each of the service providers 605a-605n for display in the screen 601. In this way, the graphical resources that are specific to the providers 605a-605n need not be hard coded or otherwise pre-included with the application 103, thereby avoiding the need for multiple customized versions of the same application across devices, networks, cell systems, etc. Moreover, if a provider decides to change its branding (e.g., logos or icons), the change may be made once on the network for propagation to the corresponding UEs 101.

When a service provider 605n is selected, the chatting service application can execute services associated with the service provider 605n. In certain embodiments, the policy rules include a parameter that indicates that a waiting screen 607 should be presented while resources (e.g., graphic resources, sound resources, etc.) associated with the service provider 605n are downloaded. These resources can be selected according to the policy rules using one or more structures for managing resources (e.g., the hierarchical structure 300 of FIG. 3). Once resources are downloaded according to the policy rules, the user can be requested to sign into the service at a login screen 609. Additionally, as noted in FIG. 5, additional resources may be downloaded at this step. In this manner, the UE 101 is able to download subsets of the resources at one or more steps (e.g., each step) of the user interface flow (e.g., from an initial splash screen to a buddy list execution for a chat application). The sequence or amount of resources to download can be dependent on the specific states of the user interface interaction. In other words, the policy rules may direct the retrieval of resources when they are needed to avoid having to download large amount of data associated with the resources at one time. Further, the chat application can utilize resource mappings and fallback resources (e.g., substitute resources) in order to determine which resource to present to a user.

Moreover, the policy rules can be utilized to block resource download of certain resources (not shown). For example, the user may be presented an option if the application determines that the download of the resources would cost the user money (e.g., if the user has a non-unlimited data plan to download from the internet, the user's network subscription has a per minute charge, etc.). As the user progresses through the user interface flow, the user can be displayed additional wait screens (e.g., wait screen 611) that include resources downloaded according to the policy rules. Once resources utilized are downloaded, the user can operate the application freely. It is contemplated that the policy rules may also interact with a cache at the UE 101 so that resources are updated periodically or according to predetermined criteria (e.g., available bandwidth, or periods in which free network access is available). In this way, the resources for a particular section of the application need not always be downloaded when the section is accessed. For example, graphical resources such as network logos, etc. traditionally do not change very often. Accordingly, the policy rule may direct the update of the network logo at relatively infrequent intervals (e.g., once every month) to reduce network use.

FIG. 6B is a diagram of a user interface utilized in the processes of FIGS. 4 and 5, according to one embodiment. The user interface 650 includes an example login screen that can be shown as part of the processes 400, 500 of FIGS. 4 and 5. In this example a banner 651 and/or another icon 653 associated with a particular service provider, operator, etc. can be downloaded and presented on the login screen. As noted previously, these resources can be downloaded according to one or more policy rules. Further, other fields 655, 657 in the user interface 650 need not be downloaded and/or updated by the policy rules. In other embodiments, the other fields 655, 657 can be customized based on the policy rules.

FIG. 6C is another diagram of a user interface utilized in the processes of FIGS. 4 and 5, according to one embodiment. This corresponding user interface 660 depicts an example login screen that can be shown as part of the processes 400, 500 of FIGS. 4 and 5 wherein one or more resources are different based on policy rules. For example, a change in the service provider, operator, or other criteria utilized to determine customizations based on the policy rules can be used to select and download different resources. As such, graphical resources (e.g., a different banner 661 and a different icon 663) associated with the different criteria can be utilized for presentation. Additionally, certain fields 665, 667 may remain the same (i.e., use default or previously downloaded resources or graphics). A manufacturer of a UE 101 or application 103 may choose this approach for customizing resources that enables distribution of a common application 103 that can be dynamically customized according to service provider needs on execution.

With the above approaches, a manufacturer of a UE 101 and/or application is able to more efficiently and more effectively package a product (e.g., an application). For example, if one or more resources are unavailable at the time the UE 101 and/or application is deployed, it can be downloaded at a later time. Further, the manufacturer can reduce the amount of different products and/or application versions. In this manner, the manufacturer need not generate separate products and/or application versions for various service providers and/or network operators. Moreover, resource bundles can have significant size, thus downloading of these resources can affect user experience because of the additional delay. Therefore, policy rules can spread delay over the user interface flow. In some cases, the user is even requested to log into an account and/or accept charges for download.

The processes described herein for managing application resources via policy rules may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

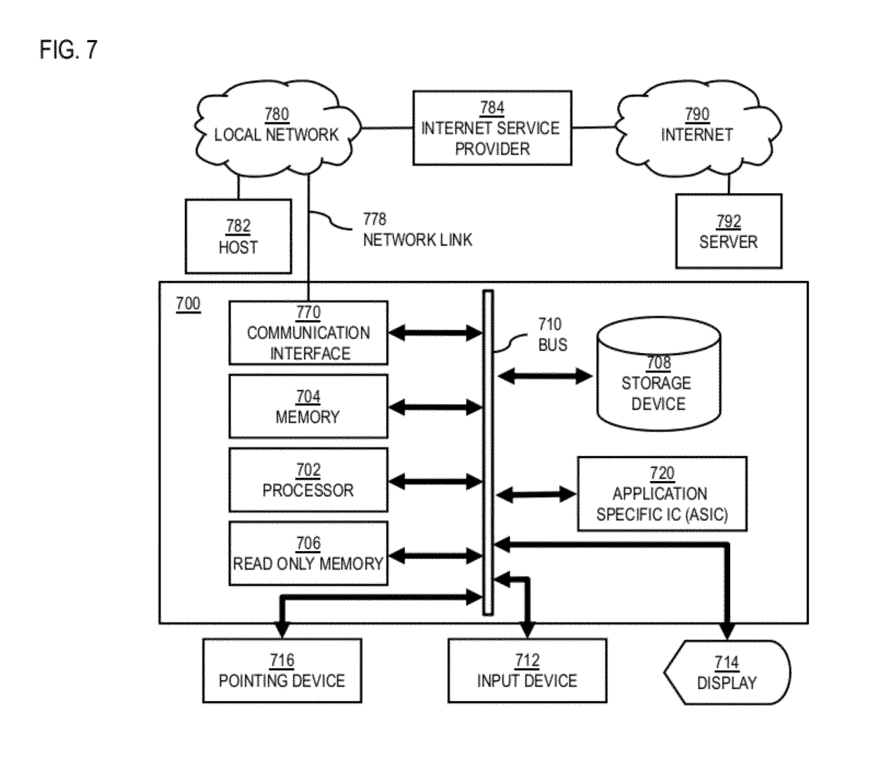

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to apply policy rules to acquire resources as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of applying policy rules to acquire resources.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to applying policy rules to acquire resources. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for applying policy rules to acquire resources. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for applying policy rules to acquire resources, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to apply policy rules to acquire resources as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of applying policy rules to acquire resources.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to apply policy rules to acquire resources. The memory 805 also stores the data associated with or generated by the execution of the inventive steps.

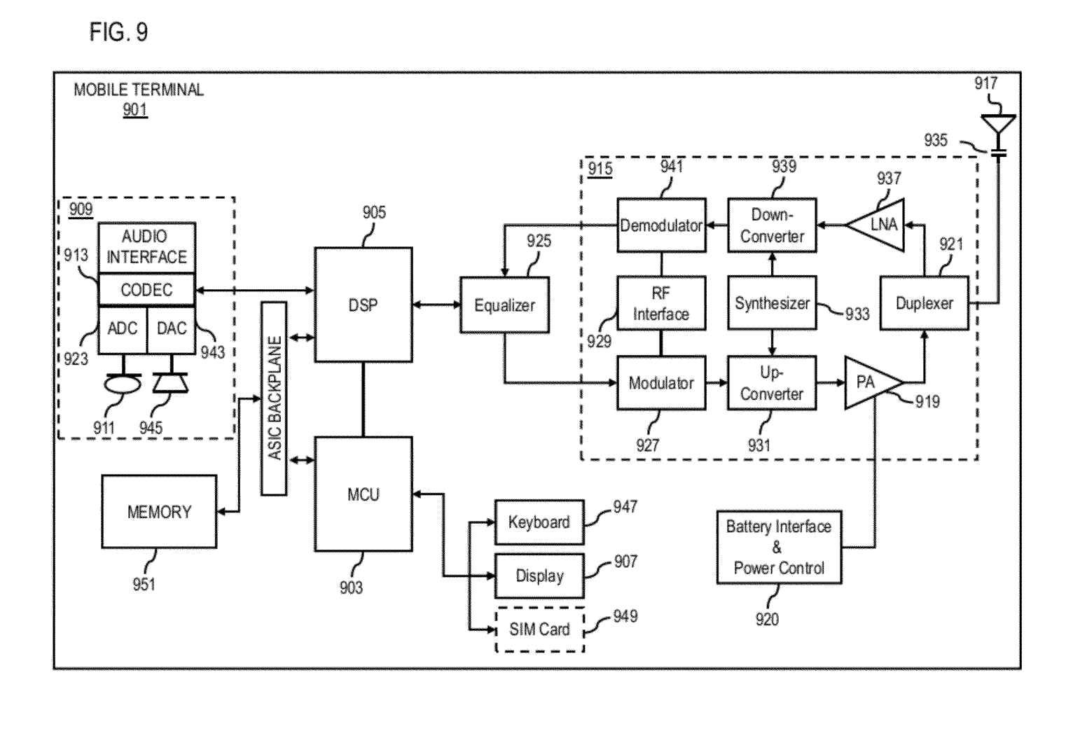

FIG. 9 is a diagram of exemplary components of a mobile terminal (e.g., handset) for communications, which is capable of operating in the system of FIG. 1A, according to one embodiment. In some embodiments, mobile terminal 901, or a portion thereof, constitutes a means for performing one or more steps of applying policy rules to acquire resources. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of applying policy rules to acquire resources. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to apply policy rules to acquire resources. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining one or more policy rules for managing one or more resources of an application executing at a device; and
determining to apply the one or more policy rules for selecting the one or more resources from among a set of resources.

2. A method of claim 1, further comprising:
determining one or more execution times, states, or a combination thereof of the application,
wherein the application of at least a portion of the one or more policy rules is based, at least in part, on the one or more execution times, the one or more states, the one or more policy rules, or a combination thereof.

3. A method of claim 1, wherein the one or more policy rules are separate from code associated with the application.

4. A method of claim 1, further comprising:
determining an initialization of the application,
wherein the determining of the one or more policy rules is based, at least in part, on the initialization.

5. A method of claim 1, further comprising:
determining a substitution condition associated with retrieving the selected one or more resources; and
determining to use one or more substitute resources based, at least in part, on the substitution condition.

6. A method of claim 1, wherein the one or more policy rules, the one or more resources, the set of resources, or a combination thereof is downloadable from another device.

7. A method of claim 6, wherein the one or more policy rules specify one or more criteria for selecting the one or more resources for download from the another device or for retrieval from a cache at the device.

8. A method of claim 1, wherein the one or more policy rules include one or more criteria for selecting the one or more resources based, at least in part, on a service provider, an operator, or a combination thereof associated with the device.

9. A method of claim 1, wherein the one or more resources includes an updated policy rule, the method further comprising:
determining to update at least a portion of the one or more policy rules based, at least in part, on the updated policy rule.

10. A method of claim 1, wherein the one or more policy rules specify respective pointers to the one or more resources, the pointers indicating one or more alternatives for the one or more resources.

11. An apparatus comprising:
at least one processor; and
at least one memory including computer program code for one or more programs,
the at least one memory and the computer program code configured to, with the at least one processor, cause the apparatus to perform at least the following,
determine one or more policy rules for managing one or more resources of an application executing at a device; and
determine to apply the one or more policy rules for selecting the one or more resources from among a set of resources.

12. An apparatus of claim 11, wherein the apparatus is further caused to:
determine one or more execution times, states, or a combination thereof of the application,
wherein the application of at least a portion of the one or more policy rules is based, at least in part, on the one or more execution times, the one or more states, the one or more policy rules, or a combination thereof.

13. An apparatus of claim 11, wherein the apparatus is further caused to:
determine an initialization of the application,
wherein the determining of the one or more policy rules is based, at least in part, on the initialization.

14. An apparatus of claim 11, wherein the apparatus is further caused to:
determine a substitution condition associated with retrieving the selected one or more resources; and
determine to use one or more substitute resources based, at least in part, on the substitution condition.

15. An apparatus of claim 11, wherein the one or more policy rules include one or more criteria for selecting the one or more resources based, at least in part, on a service provider, an operator, or a combination thereof associated with the device.

16. An apparatus of claim 11, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

17. A computer-readable storage medium carrying one or more sequences of one or more instructions which, when executed by one or more processors, cause an apparatus to at least perform the following steps:
determining one or more policy rules for managing one or more resources of an application executing at a device; and
determining to apply the one or more policy rules for selecting the one or more resources from among a set of resources.

18. A computer-readable storage medium of claim 17, wherein the apparatus is caused to further perform:
determining one or more execution times, states, or a combination thereof of the application,
wherein the application of at least a portion of the one or more policy rules is based, at least in part, on the one or more execution times, the one or more states, the one or more policy rules, or a combination thereof.

19. A computer-readable storage medium of claim 17, wherein the one or more policy rules are separate from code associated with the application.

20. A computer-readable storage medium of claim 17, wherein the apparatus is caused to further perform:
determining an initialization of the application,
wherein the determining of the one or more policy rules is based, at least in part, on the initialization.

21.-46. (canceled)
